(19) United States
(12) Patent Application Publication
(10) Pub. No.: US 2016/0318271 A1
(43) Pub. Date: Nov. 3, 2016

(54) Elevated Pressure and Temperature Tire Curing Utilizing Liquids

(71) Applicant: BRIDGESTONE BANDAG, LLC, Muscatine, IA (US)

(72) Inventor: Noel K. Stineman, Grandview, IA (US)

(21) Appl. No.: 15/108,375

(22) PCT Filed: Dec. 16, 2014
(86) PCT No.: PCT/US14/70443

§ 371 Date: Jun. 27, 2016

Related U.S. Application Data
(60) Provisional application No. 61/921,144, filed on Dec. 27, 2013.

(51) Int. Cl. B29D 30/54; B60C 11/02

(52) U.S. Cl. CPC B29D 30/542; B60C 11/02; B29D 2030/546; B29D 2030/548

(57) ABSTRACT

A method provides a retreaded tire by curing a tread with tread lugs extending from an under tread and tread voids between the tread lugs onto a tire casing. The tread and at least a portion of the tire casing are sealed in an envelope in a manner that provides voids, including the tread voids, within the seal of the envelope. The enveloped tire casing and tread are positioned within a vessel and a liquid is introduced into the envelope to fill at least some of the voids around the tread. The pressure and temperature in the vessel is increased in order to connect the tread to the tire casing by compressing and heating the tire casing and tread. In the presence of the liquid, the tread and tire casing maintain their shape despite the elevated pressure and temperature.

### BACKGROUND

The present disclosure relates generally to a method of retreading tires, a system for retreading tires and tires that are manufactured in such manner.

Tire retreading can provide an economical way to use the full life of a tire casing after the original tread, or a previously-applied retread, has become worn. In cold process retreading, a pre-cured tire tread may be attached to a prepared tire casing in a vulcanizing chamber at elevated temperature and pressure. While the increased pressure aids in maintaining the tread against the tire casing as the curing proceeds, the elevated pressure can also result in deformations in the tread and resultant tire structures. In particular, the pressure exerted on the tread and tire structures can cause the voids between tread structures to collapse, such that neighboring tread structures can become crowded together, among other problems.

### BRIEF SUMMARY

The disclosure provides, among other things, a method of retreading a tire casing by placing a tread with tread lugs extending from an under tread and tread voids between the tread lugs onto a tire casing. The tread and at least a portion of the tire casing are sealed in an envelope in a manner that provides voids, including the tread voids, within the seal of the envelope. The enveloped tire casing and tread are positioned within a vessel and, at the same or a different time, a liquid is introduced into the envelope to fill at least some of the voids associated with the tread. The pressure and temperature in the vessel is increased in order to press the tread to the tire casing by compressing and heating the tire casing and tread. In the presence of the liquid, the tread and tire casings maintain their shape despite the elevated pressure and temperature.

The disclosure provides for other embodiments, including embodiments of a retreaded tire formed by a method using liquid disposed within a curing envelope and a system for manufacturing a retreaded tire.

### BRIEF DESCRIPTION OF THE DRAWINGS

The detailed description below references the exemplary figures. The invention is not limited to the exemplary figures on embodiments. All features described and/or illustrated herein can be used alone or combined in different combinations in embodiments of the invention. The features and advantages of various embodiments will become apparent by reading the following detailed description with reference to the attached drawings which illustrate the following:

FIG. 1 shows an exploded cross section of the components used in retreading a tire;

FIG. 2 shows a diagram illustrating a retreading method in accordance with an embodiment;

FIG. 3 shows a schematic view of a tire retreading system in accordance with an embodiment;

FIG. 4 shows a cross section of a portion of a tire assembly within an envelope during a retreading procedure;

FIG. 5 shows a retread tire corresponding to the assembly shown in FIG. 4;

FIG. 6 shows a cross section of a portion of a tire assembly within an envelope during a retreading procedure in accordance with an embodiment; and

FIG. 7 shows a retread tire corresponding to the assembly shown in FIG. 6.

### DETAILED DESCRIPTION

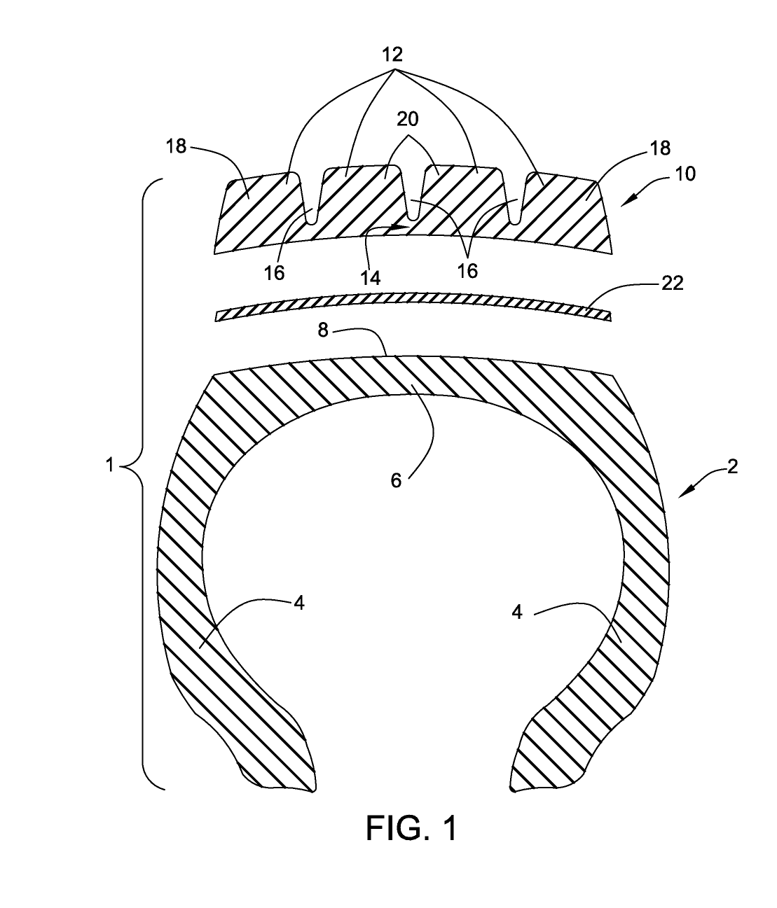

In a method of retreading a tire casing, sometimes referred to as cold process retreading, a pre-cured tire tread is attached to an existing tire casing that has been processed for receiving a new tread. The components of a tire assembly 1 that are used in a retreading process are shown in FIG. 1. The tire casing 2 has been inspected for punctures or damage along both the side walls 4 and the circumferential crown 6. The crown 6 has been prepared for the new tread 10 by buffing and other preparatory processes. Similar to many tires, the casing 2 includes an elastic material such as natural or synthetic rubber or a mixture that is secured with belts, cords, plies and wires of metal or polymer materials. The tread 10 may be a pre-cured elastic material, for example of natural or synthetic rubber or a mixture, and is applied to the outer surface 8 of the crown 6 during the retreading process. Alternatively, the tread 10 may be uncured. The tread 10 includes a plurality of structures, or tread lugs 12, that extend radially outward from a comparatively thin under tread 14. The tread lugs 12 are separated by voids 16, which are typically arranged to provide a tread pattern. The tread lugs 12 can be formed in any number of arrangements, including as circumferential ribs that extend around the entire outer surface of the tire or by individual tread blocks that extend individually upward from the under tread 14 and are free on all sides. Of course, a hybrid of these tread lugs is also possible, where a circumferential rib may include shallow grooves around the circumference of the tire that do not extend all the way to the under tread. In the illustrative embodiment of FIG. 1, the outer tread lugs 18, which are disposed adjacent to the side walls 4, are circumferential ribs and the inner tread lugs 20 are tread blocks. The outer tread lugs 18 can also be tread blocks. Preferably, at least some of these tread blocks are elongate in the circumferential direction of the tire, such that a dimension of the tread block in the circumferential direction is larger than a dimension of the tread block in the axial direction of the tire.

In an illustrated embodiment, the tread 10 is pre-cured and is attached to the crown 8 of the tire casing 2 using a bonding material 22, such as cushion gum, which is cured during a heating process to facilitate secure attachment of the tread 10 to the casing 2. The tread 10 could also be attached directly to the tire casing 2.

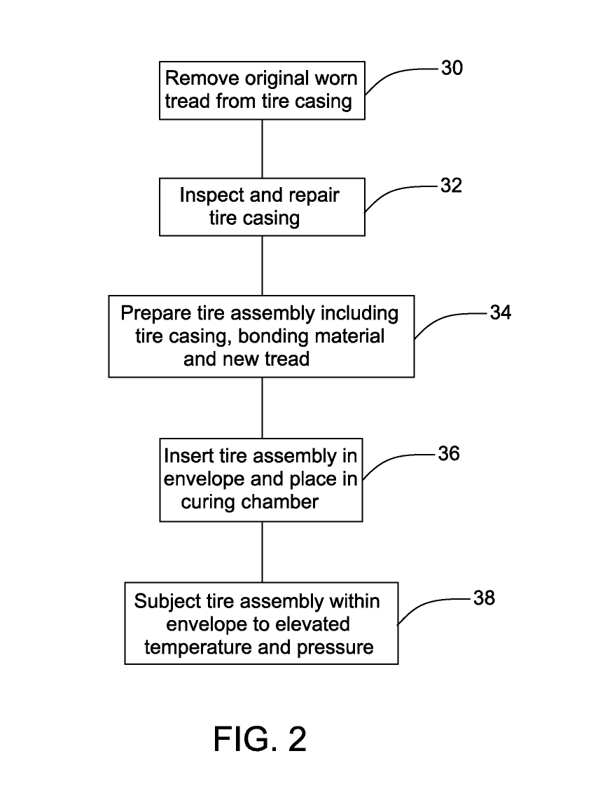

Details of the retreading process are shown in more detail in the diagram presented in FIG. 2. In an initial step 30, the worn tire tread on a used tire is removed to create a treadless surface about the circumference of the tire casing. Preferably, this outer surface is buffed so that it is generally smooth and prepared for bonding to a new tread or tread assembly.

The tire casing is typically inspected for injuries and, if possible, repaired in step 32. The inspection can include a visual inspection by a specialist or a machine inspection. Preferably, both the side walls 4 and the crown 8 are inspected for cracks, gashes and tire penetrations. In a particularly rigorous inspection, the tire can be inspected while under certain loading conditions. Once identified, the injuries in the tire casing may be skived and filled with a repair gum or mended in some other manner. If the injuries are too severe for repair, the casing may be rejected. While the tread removal is described and shown in FIG. 2 as being carried out before the inspection and repair of the tire casing, this step can alternatively be carried out after or in the middle of the inspection and repair step.

After any injuries are repaired, the components of the tire are assembled in step 34. Specifically, the buffed outer surface of the tire casing may be coated with a tire cement that provides a tacky surface for application of other bonding material and a new tread. A layer of cushion gum may be applied to the inside surface of the new layer of tread, or alternatively, the layer of cushion gum may be applied directly to the tacky surface on the tire casing. As an example, the cushion gum may be a layer of uncured rubber material. The cushion gum and tread can then be applied in combination about the circumference of the tire casing to create a retread tire assembly for curing. As an alternative, a length of tire tread may be wrapped around the tire casing with the cushion gum present. In a preferred embodiment, these steps can be carried out using a tire builder that allows more precise placement of the cushion gum and tread on the crown of the tire as it is rotated.

Following assembly of the tire casing, cushion gum and tread, the tire assembly may be placed within a flexible envelope in step 36. In one embodiment, an airtight seal is created between the envelope and the bead of the tire. Preferably, the envelope is flexible enough and appropriately shaped to form a tight fit over most of the outer surfaces of the tire assembly, including the outer surface of the tread lugs 12. However, the depth of the voids 16 between the tread lugs 12 is typically too deep for the envelope to penetrate and at a least a portion of these voids remain empty after the envelope is secured in place. The tire assembly and envelope are then placed in a curing chamber.

In step 38, the temperature and pressure within the chamber are elevated to facilitate curing of the cushion gum 22. The increased pressure helps maintain the tread 10 against the tire casing 2 as the cushion gum 22 is cured by the elevated temperature. Specifically, the elevated temperature facilitates chemical reactions within the tire assembly that cause it to securely bond the tire casing 2 and the new tire tread 10.

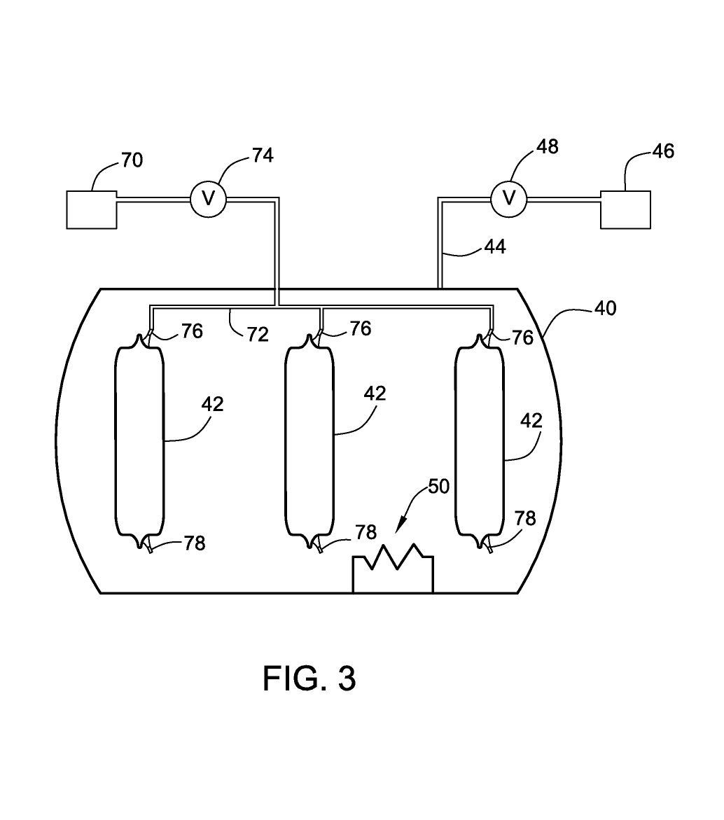

FIG. 3 shows a schematic view of a system for retreading a tire. The system includes an autoclave or pressure vessel 40 that receives one or more enveloped tire assemblies 42. As described above, these assemblies 42 have a tire casing, bonding material and replacement tread inside of a flexible envelope. The interior space within the vessel 40 is connected by a conduit 44 to a pressure source 46. The pressure source 46 is operable to pressurize the vessel 40 with air, steam or a combination of air and steam The introduction of the pressure medium may be controlled by a valve 48 that is disposed in the conduit 44 or that forms part of the pressure source 46.

In addition to increasing the pressure within the vessel, the curing process also includes heating the interior of the vessel to an elevated temperature. In the illustrated embodiment, the rise in temperature is achieved using a heater 50. In some embodiments, the pressure medium can be introduced into the vessel in a heated state. It is also possible to heat the medium after it is introduced to the vessel 40. In some instances it may be advantageous to use a heater in addition to pre-heating the medium to maintain the elevated temperature. In an embodiment, the temperature within the vessel 40 is elevated to at least 200° F., for example 210° F. The pressure and temperature within the vessel can be elevated separately, for example by increasing the pressure before the inside of the vessel is heated. The heating and pressurizing of the vessel 40 can either overlap or be carried out simultaneously.

During a curing operation, the vessel 40 is pressurized to an elevated pressure that is sufficient to hold the envelope tightly against the tire assembly and to press both the pre-cured tire tread and tire casing against the cushion gum with enough force to form a strong bond between these components during the curing process. In an example embodiment, the pressure in the vessel is about 85 psi. In other embodiments, the pressure within the vessel may be lower. As a further alternative, physical constraints may be used to press the components of the tire assembly together, which may allow lower pressure to be used within the vessel or autoclave 40.

While the increased pressure within the vessel is advantageous for the curing process, it can also cause certain drawbacks that may need to be addressed. For example, the added pressure against the tread lugs, particularly the outer tread lugs, can force the tread lugs together and collapse the groove or void therebetween (see FIG. 5). If the tire assembly is cured in this position, the size of the void between the outer tread lug and adjacent inner tread lug can be reduced or closed entirely.

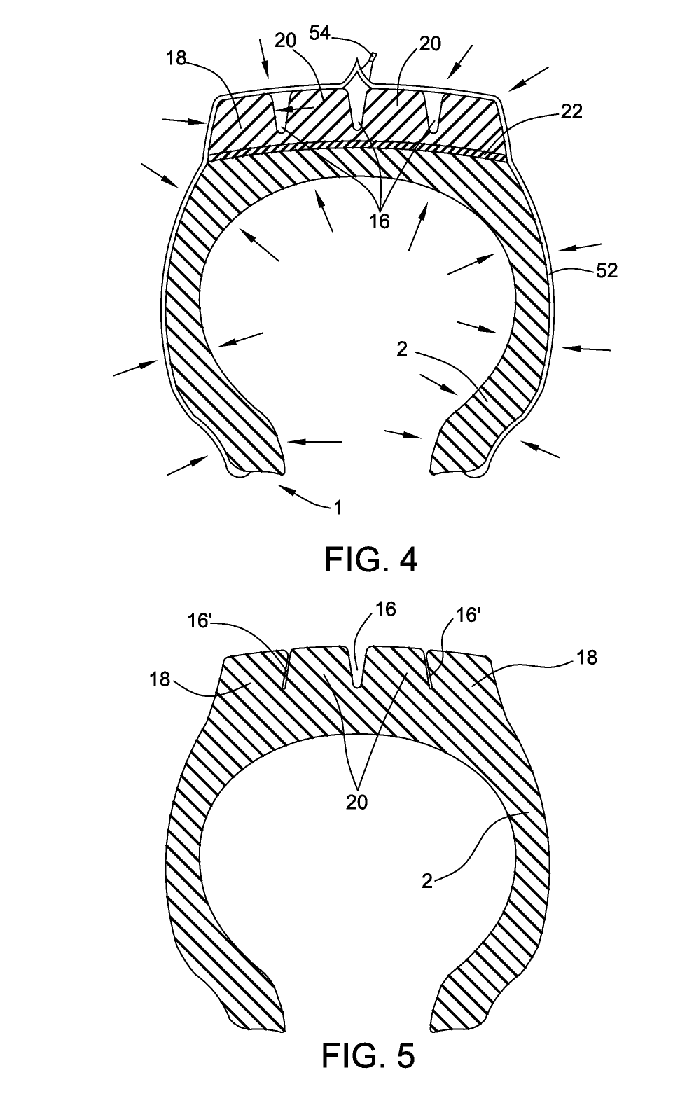

In an embodiment, each envelope 52 can include a fluid inlet 54 that allows the inside of the envelope to be pressurized so as to provide a controllable differential pressure between the inside of the envelope and the surrounding vessel 40, as shown in FIG. 4. As a result, voids within the envelope, particularly those voids 16 between tread lugs 12 can be subjected to a controlled pressure. In many instances, the internal force provided on the tread lugs 12 within the envelope is sufficient to counteract the force exerted by the pressure medium outside of the envelope 52. For example, the use of a differential pressure within the envelope 52 that is about 15 psi less than the elevated pressure within the vessel has been attempted to prevent void collapse. If the under tread 14 is too thin, the pressure within the envelop may not be enough to prevent distortion of the treads, particularly collapse of the outer voids 16′, as shown in FIG. 5. For a particular tread design and a pressure differential of 15 psi between the inside of the envelope and the surrounding pressure vessel, an unexpected jump in tread distortion was consistently observed for retread tires with under treads smaller than 0.090 inches. Although the distortion of the tread lugs and voids can be circumvented by using an under tread of greater thickness or a lower pressure differential, such is not advantageous. The sheer volume of rubber used in the manufacture and retreading of tires allows reductions in the under tread of even thousandths of an inch to yield substantial cost savings. Further, modifying the pressure within the envelope or in the surrounding vessel so as to reduce the differential pressure can lead to gas bubbles in undesired locations within the envelope.

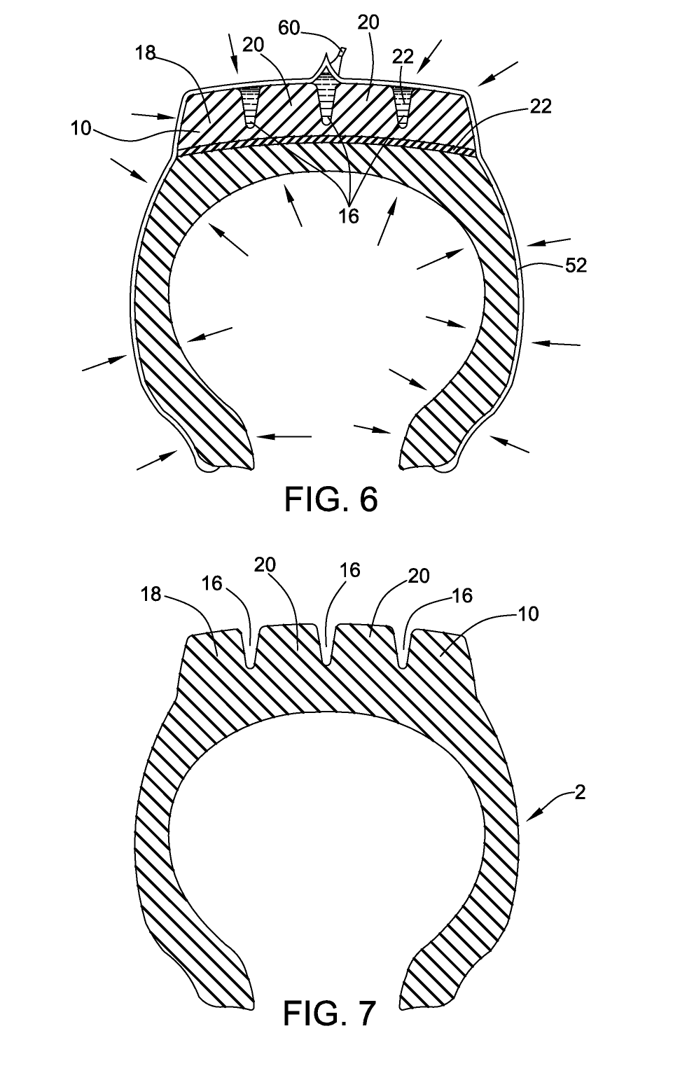

FIG. 6 shows an envelope assembly including a tire assembly within the envelope 52 with a liquid 62 disposed within the voids between the tread 10 and the envelope 52, particularly within the tread voids 16. In the illustrated embodiment, the liquid 62 is introduced to the inside of the envelope 52 through an inlet 60, as described in more detail below. As the pressure within the vessel increases and begins to exert a force on the outer tread lug 18 that might otherwise cause distortion, the liquid within the voids 16 surprisingly provides a counteracting force maintaining the integrity of the casing and tread assembly. As a result, the completed retread tire, as shown in FIG. 7, is produced without any undesired distortion of the tread lugs or substantial collapsing of the voids 16. The avoidance of distortion associated with the use of liquid in the voids may allow the under tread 14 of the tire to be substantially reduced in thickness compared to conventional pre-cured tread.

It is also possible to combine the processes illustrated by FIGS. 4 and 6. For example, the envelope 52 could include a first inlet in communication with certain voids in the tread, such as grooves or indentations, so that these voids can be filled with a substantially incompressible liquid during the curing process. The envelope 52 could also include a second inlet in communication with other voids that are isolated from the liquid filled voids. These other voids could then be subjected to a differential pressure with the surrounding vessel.

In an example embodiment, the liquid introduced into the voids within the envelope 52 is water, which is substantially incompressible. In order to enhance the performance of the water, certain additives can be added to the water to change certain characteristics, such as its boiling temperature or its predisposition to thermal expansion. Alternatively, other liquids can be used as an incompressible fluid so as to avoid a phase change during the curing process. Due to the reactive force exerted by the liquid within the envelope, it may be possible to operate the pressure vessel at lower pressures than would otherwise be necessary. In a preferred embodiment, the differential pressure within the vessel is raised to at least 15 psi during the curing step. However higher pressures, such as around 85 psi, are also possible, especially if the pressures within the envelop are elevated.

The method of using the liquid 62 in the curing process is further illustrated with reference to FIG. 3. As shown, the assembly in FIG. 3 includes a water source 70 that is connected to one or more water conduits 72 associated with each of the enveloped tire assemblies 42. In order to introduce the water into the enveloped assemblies, each envelope includes an inlet 76 with a connector that is adapted to be connected to a corresponding one of the water conduits 72. Preferably, the inlet 76 is disposed on one side of the assembly 42 and an outlet conduit 78 is disposed on an opposite side of the assembly. In order to fill the envelopes 52 with the water, each inlet 76 is connected to the corresponding water conduit 72 and the outlet conduit 78 is opened. Preferably, the opening of the outlet conduit 78 is achieved using an actuatable valve that controls flow through the conduit. A control valve 74 is then actuated to allow the flow of water from the water source 70, through the conduits 72, to the respective enveloped assemblies 42. As the water flows into the envelope, the voids therein begin to fill and any air within the envelope is expunged. As shown in FIG. 3, the inlet 76 and outlet conduit 78 can be positioned on the envelope so as to allow the inlet to be placed at the top of the assembly 42 during the filling process, with the outlet 78 at the bottom of the assembly 42. Accordingly, this allows the water to be gravity fed into the envelope without requiring the water to be introduced at a pressure above atmospheric.

In an alternative embodiment, the inlet 76 may be placed at or near the bottom of the envelope. As liquid is introduced to the envelope, an outlet conduit placed at or near the top of the envelope permits air or other gasses to escape. When the envelope is sufficiently full, the outlet conduit may be closed and the inlet sealed. After vulcanization, the outlet conduit near the top may be opened and the liquid recovered by reverse flow out the inlet positioned at or near the bottom of the envelope. The envelope could also include a single inlet through which both the liquid is introduced into the envelope and the gasses in the envelope are expunged.

Once the voids within the envelope are filled or substantially filled, the flow of water may be shut off using valve 74 and the outlet conduits 78 of each assembly 42 can be closed. As mentioned above, while the pressure within the vessel or autoclave 40 increases, the liquid within the envelope results in the shape of the tread being surprisingly maintained.

While the above embodiment describes the liquid as being added to the envelope assemblies 42 while the assemblies are disposed within the vessel 40, it is also possible to add the liquid outside of the vessel. For example, each of the envelope assemblies could be filled with the liquid at a filling station and then placed within the autoclave 40.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of retreading a tire casing comprising:
providing a tire assembly including a tire casing and a tread, the tread comprising tread lugs extending from an under tread and forming tread voids between the tread lugs;
surrounding at least portion of the tire assembly with an envelope that encloses the tread between the tire casing and the envelope in a sealing manner such that voids exist including said tread voids between the tread lugs;
disposing the tire assembly and envelope in a vessel;
introducing a substantially incompressible liquid into the envelope and at least some of the tread voids between the tread lugs;
increasing pressure and temperature within the vessel to an elevated curing pressure and curing temperature so as to compress and heat the tire assembly with the substantially incompressible liquid present in the voids, said tire assembly substantially maintaining its shape in the presence of the substantially incompressible liquid despite the elevated pressure and temperature.

2. The method recited in claim 1, wherein the substantially incompressible liquid is water.

3. The method recited in claim 2, wherein the water is introduced into the chamber at atmospheric pressure.

4. The method recited in claim 1, wherein the providing the tire assembly includes placing a bonding material between the tire casing and the tire tread.

5. The method recited in claim 4, wherein the increasing pressure and temperature within the vessel cures the bonding material so as to attach the tire tread to the tire casing.

6. The method recited in claim 1, wherein the elevated curing pressure is at least 15 psi greater than a pressure inside the envelope.

7. The method recited in claim 1, wherein the introducing the substantially incompressible liquid into the envelope includes expunging air from within the envelope.

8. The method recited in claim 7, wherein the substantially incompressible liquid is gravity fed into the envelope.

9. The method recited in claim 1, wherein the vessel is an autoclave.

10. A retreaded tire comprising:
a tire casing including sidewalls;
a tire tread attached to the tire casing, the tire tread including tread lugs extending from an under tread and forming tread voids between the tread lugs,
wherein the tire tread is attached to the tire casing by subjecting the tire casing and tire tread to increased pressure and temperature within a vessel, such tire tread and casing being surrounded by an envelope that encloses the tread between the tire casing and the envelope in a sealing manner such that voids exist including said tread voids between the tread lugs; and
wherein a substantially incompressible liquid is introduced into the envelope which fills at least some portion of the voids with the substantially incompressible liquid such that increasing pressure and temperature within the vessel for curing with the substantially incompressible liquid present in at least some portion of the voids results in a retreaded tire where the shape of the tread is substantially maintained despite the elevated pressure and temperature during curing.

11. The retreaded tire recited in claim 10, wherein the tread lugs include an outer tread lug adjacent to one of the sidewalls in the form of a circumferential rib.

12. The retreaded tire recited in claim 10, further comprising a bonding material that attaches the tire tread to the tire casing when the tire casing and tire tread are subjected to the increased pressure and temperature .

13. The retreaded tire recited in claim 10, wherein the tread lugs include an outer tread lug adjacent to one of the sidewalls in the form of a tread block, the tread block having a first dimension in a circumferential direction of the tire that is greater than a second dimension in an axial direction of the tire.

14. A system for retreading a tire casing, the system comprising:
a vessel;
a pressure source operable to increase pressure within the vessel;
a heat source operable to increase a temperature within the vessel; and
an envelope configured to surround at least a portion of a tire casing and tread, the envelope including an inlet configured to receive a substantially incompressible liquid and an outlet conduit for escaping air from within the envelope; and
wherein the substantially incompressible liquid passes through the inlet into tread voids within the envelope in a manner that permits the curing of the tread to occur without substantially deforming the tread.

15. The system recited in claim 14, further comprising the tire casing and tire tread disposed within the envelope.

16. The system recited in claim 14, wherein the vessel is an autoclave.

17. The system recited in claim 14, wherein the outlet conduit includes a valve.

18. The system recited in claim 14, further comprising a conduit configured to provide the substantially incompressible liquid to the inlet of the envelope.

19. The system recited in claim 18, wherein the conduit includes a first connection and the inlet of the tire casing includes a second connection for mating with the first connection of the conduit.

20. The system recited in claim 19, wherein the outlet includes a valve having a construction that is different from the construction of the second connection of the inlet.
